(19) United States
(12) Patent Application Publication
(10) Pub. No.: US 2013/0218733 A1
(43) Pub. Date: Aug. 22, 2013

(54) METHOD AND SYSTEM FOR DATA MANAGEMENT AND MONETIZATION

(71) Applicants: Carlo RAGO, Baltimore, MD (US); Anindo Bandyopadhyay, Banglore (IN); Shelley Alyssa Batts, Los Altos Hills, CA (US)

(72) Inventors: Carlo RAGO, Baltimore, MD (US); Chris Bunnell, Old Orchard Beach, ME (US); Anindo Bandyopadhyay, Banglore (IN); Shelley Alyssa Batts, Los Altos Hills, CA (US)

(21) Appl. No.: 13/465,791

(22) Filed: May 7, 2012

Related U.S. Application Data
(60) Provisional application No. 61/482,964, filed on May 5, 2011.

(51) Int. Cl. G06F 17/22; G06Q 40/00

(52) U.S. Cl. CPC G06F 17/2235; G06Q 40/10
USPC 705/30; 715/205

(57) ABSTRACT

An apparatus, method, and system for linking out to product websites in an electronic laboratory journal environment are disclosed. The apparatus, method, and system comprising a module for receiving a content entry in a content space, a module for receiving a hyperlink associated with the content entry in the content space, the hyperlink configured to link out to a third party website with affiliation to the content entry, and a module for generating in the content space a content entry listing having embedded therein the hyperlink that is configured to link out to the third party website.

### CLAIM OF PRIORITY UNDER 35 U.S.C. §119

This application claims the benefit of and priority to U.S. Provisional Patent Application No. 61/482,964, titled “Method and System for Data Management and Development-Cycle Optimization,” filed May 5, 2011, the disclosure of which is hereby incorporated in its entirety by reference herein.

### BACKGROUND

1. Field

Aspects of the present invention generally relate to data management systems, and more particularly to methods and systems for creating, storing, managing, and publishing scientific protocols and formulations, monetization and distribution of revenue.

2. Introduction

Scientific publications typically disclose scientific findings to the public for a fee. These fees, however, are costly. Citizens, foundations and patient-advocacy groups strongly prefer free access to information because it accelerates scientific research.

There are two things that contribute to the cost of publication, one is the editorial process and the second is brand. The stronger the brand is, the more money the holders of the brand can command. Furthermore, profits are not generally redistributed to the authors. Therefore, there exists an unmet need in the art for a system and method for providing an open-access journal that crowd sources the editorial process by facilitating peer-review, which greatly reduces the cost and hurdle to publish scientific journals and may allow redistribution of resources to authors.

### SUMMARY

According to an aspect of the present invention, a method for linking out to product websites in an electronic laboratory journal environment may include receiving a content entry in a content space, receiving a hyperlink associated with the content entry in the content space, the hyperlink configured to link out to a third party website with affiliation to the content entry, and generating in the content space a content entry listing having embedded therein the hyperlink that is configured to link out to the third party website.

According to another aspect of the present invention an apparatus may include a contribution module configured to receive a content entry in a content space, receive a hyperlink associated with the content entry in the content space, the hyperlink configured to link out to a third party website with affiliation to the content entry, and a linking module configured to generate in the content space a content entry listing having embedded therein the hyperlink that is configured to link out to the third party website.

According to yet another aspect of the present invention a system may include means for receiving a content entry in a content space, means for receiving a hyperlink associated with the content entry in the content space, the hyperlink configured to link out to a third party website with affiliation to the content entry, and means for generating in the content space a content entry listing having embedded therein the hyperlink that is configured to link out to the third party website.

According to yet another aspect of the present invention, a computer program product including a non-transitory computer-readable medium having control logic stored therein for causing a computer to perform linking, the control logic may include code for receiving a content entry in a content space, code for for receiving a hyperlink associated with the content entry in the content space, the hyperlink configured to link out to a third party website with affiliation to the content entry, and code for for generating in the content space a content entry listing having embedded therein the hyperlink that is configured to link out to the third party website.

According to yet another aspect of the present invention, a method for linking out to product websites in an electronic laboratory journal environment may include detecting a content entry in a content space, searching a database using an algorithm that is configured to identify product listings within the database that are similar to the content entry, determining whether similar product listings have been identified, generating at least one similar product listing embedded with a hyperlink to a third party website with affiliation to the at least one similar product listing, and displaying within the content space the at least one product listing adjacent to the content entry.

According to yet another aspect of the present invention, a method for measuring contribution by authors and redistribution of revenue to authors may include quantifying contribution by authors based on parameters attributed to each of the authors and content submissions of each of the authors, the parameters including a number of the content submissions by each of the authors, a rating of the content submission, a total number of views of the content submissions, a number of unique views of the content submissions, and an average viewing time of the content submissions, and distributing awards to each of the authors based on the respective quantified contribution of each of the authors.

It is understood that other aspects of the invention will become readily apparent to those skilled in the art from the following detailed description, wherein various aspects of the present invention are shown and described by way of illustration only. As will be understood, the present invention is capable of other and different variations and its several details are capable of modification in various other respects, all without departing from the scope of the invention. Accordingly, the drawings and detailed description are to be regarded as illustrative in nature and not as restrictive.

### BRIEF DESCRIPTION OF THE DRAWINGS

These and other sample aspects of the disclosure will be described in the detailed description and the appended claims that follow, and in the accompanying drawings, wherein:

FIG. 1 is an example block diagram illustrating a simplified system for facilitating peer-review via a portal, in accordance with aspects of the present invention;

FIG. 2 is an example block diagram illustrating a system for contributing, managing, and monetizing content, in accordance with aspects of the present invention;

FIG. 3 illustrates an example flow diagram of a method for embedding hyperlinks in a content space, in accordance with aspects of the present invention;

FIG. 4 illustrates an example flow diagram of a method for generating similar product listings in a content space, in accordance with aspects of the present invention;

FIGS. 5A-5H illustrate example screen shots of various aspects of the present invention.

FIG. 6 depicts a computer system for implementing various aspects of the present invention; and

FIG. 7 is a block diagram of various example system components, in accordance with aspects of the present invention.

In accordance with common practice, the various features illustrated in the drawings may be simplified for clarity. Thus, the drawings may not depict all of the components of a given apparatus or method. In addition, like reference numerals may be used to denote like features throughout the specification and figures.

### DETAILED DESCRIPTION

Various aspects of the present invention are described below. It should be apparent that the teachings herein may be embodied in a wide variety of forms and that any specific structure, function, or both being disclosed herein may be merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality, in addition to or other than one or more of the aspects set forth herein. An aspect may comprise one or more elements of a claim.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

Various aspects of the present invention solve the above-identified needs, as well as others, via devices, methods, and systems capable of providing an open-access journal that crowd sources the editorial process by facilitating peer-review.

FIG. 1 is an example block diagram illustrating a system 100 for facilitating peer-review via a portal in accordance with aspects of the present invention. The system 100 may include a plurality of user types, such as authors 104a-n and users 106a-n that may interface with portal 102 through one or more access terminals in communication with the portal 102.

For purposes of this discussion, authors 104a-n may be those individuals or organizations who are registered and are providing content 108a-n and using both private and public types of content 108a-n within the system 100. Whereas users 106a-n may be those individuals or organizations who are not registered but are using publicly available content within the system 100. Authors 104a-n may be treated as users 106a-n when not logged in to the portal 102.

The system 100, via the portal 102, may provide for an environment that is an amalgamation of an electronic laboratory notebook, open access journal, wiki, and blog, and that may be configured to return to the contributors by sharing a large fraction of all associated profit that is gained from the content. The system may provide an environment and interface for authors 104a-n (e.g., scientists, non-profit organizations, etc.), where scientists can create, store, manage, and share publicly or privately their work in the form of content 108a-n (e.g., buffer, formulation, chemistry, life science and other scientific protocols).

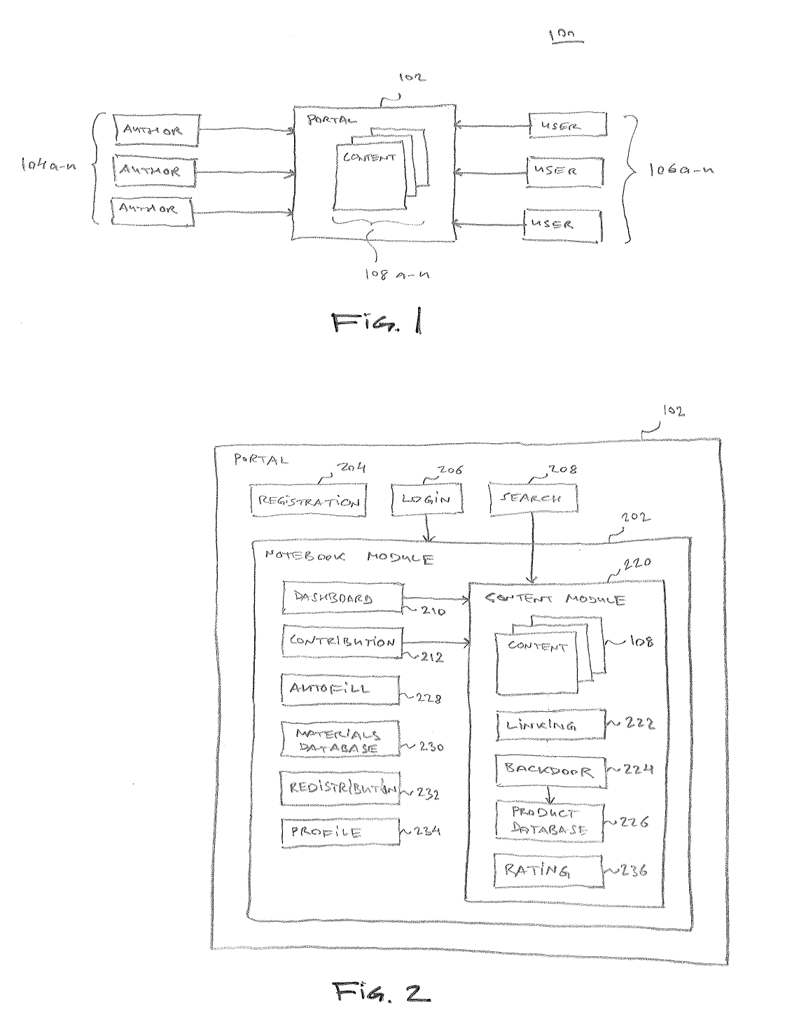

FIG. 2 is an example block diagram illustrating a system 200 for contributing, managing, and monetizing content, in accordance with aspects of the present invention. In order to access a notebook module 202 where author 104 may submit and rate content, the author 104 may be required to first register with the portal 102.

For the author 104, registration may commence when the author 104 triggers a registration event when interfacing with registration module 204 of the portal 102. For example, the registration event may be triggered by the author 104 clicking or otherwise selecting a registration hypertext link on an access terminal that is in communication with the portal 102.

Once the registration event is triggered, the registration module 204 may prompt the author 104 to submit access credentials of choice, such as a name, e-mail address, username, and password. When the registration module 204 detects that the author 104 has provided the information in all of the required text fields and submitted the access credentials, the registration module 202 may transfer the author 104 to the notebook module 202. Once the author 104 is registered, the author 104 may login to or otherwise access the notebook module 202 using the author's access credentials.

For each author 104 that has completed the registration process and logged in to the notebook module 202, the notebook module 220 may generate a unique notebook space specific to that author 104. The notebook space may provide a secure and dynamic environment that may be accessible only via the corresponding access credentials the author 104 selected during the registration process. For example, the notebook space may be secured by SSL (https), server side encryption, or other encryption methods. When the author 104 logs in to the notebook module 202 using their access credentials, the notebook module 202 may display the notebook space to the author 104 on their respective access terminal.

The author 104 may commence submission of content by triggering a submission process, which may be triggered by the author 104 clicking on an “add content” link on a navigation bar in the notebook space, for example. The content submission process may be controlled by a contribution module 212.

When the author 104 triggers the content submission process, the contribution module 210 may detect the trigger and display to the author 104 a contribution space. The contribution space may include options for submitting various kinds of content 108, such as materials, protocols, formulations, publications, etc.

Furthermore, the contribution space may include various means of inputting information and selecting options, such as text fields, radio buttons, and check boxes. For example, the contribution space may include a content format option, which allows the author 104 to designate the content as private or public. The contribution space may also include selectable categories to facilitate the description of the content. For example, the categories may include DNA, RNA, proteins, lipids, cells, metabolites, buffers, formulation, lab equipment, hardware, software, etc. The contribution space may also provide for text entry of the content title, introduction, and key words relevant to the content, as well as check boxes and text fields for indicating the use(s) of the content, such as whether the use is biochemical, in-vivo, tissue culture, synthesis, molecular biology, or other. The contribution space may also include fields for submitting descriptions of materials related to the content, such as the material's catalog number, the material's name, the name of the company manufacturing and/or selling the material, the material's use, and a hyperlink to the material on the company's website. The contribution space may also include a means for uploading any attachments, as well as fields for entering information on references, such as publication numbers, titles, etc.

The contribution space may also provide the author 104 with an ability to associate various media with the content 108, such as pictures, graphs, charts, video, etc.

Further still, the contribution space may include a separate submission space for submission of materials as independent content for a designated materials database 230. Submission of materials may facilitate record keeping of the materials the author 104 (e.g., scientist/researcher) has in stock. For example, the various material-related entries may include the material's catalog number, the material's name, the name of the company manufacturing and/or selling the material, a hyperlink to the material on the company's website, the location of the material (e.g., freezer #5, top shelf), the date the material was received, the expiration date of the material, the amount of the material remaining, whether the material is hazardous or not, and any comments the author 104 may have regarding the material.

According to some aspects of the present invention, the contribution module 212 may provide a mechanism for the author 104 to submit the content. For example the contribution module 212 may provide an option to either save the content 108 to a dashboard module 210 for later editing, or to elect to publish the content 108. A set number, such as four or more publication settings may be offered (e.g., Private Draft, Private Versioned, Public Draft, Public Versioned) and the author 104 may choose the desired type for submission. The author 104 may update “Drafts,” but these changes may only replace the old information. The author 104 can update “Versioned” content 108 and these changes may result in a new version of the content 108. Content published as “Public” may be published by the content module 220 under an open access licensing agreement, such as Creative Commons CC-BY. This license allows the author 104 to retain the right to attribution while allowing the world to prosper from sharing.

After the author 104 provides any or all of the information concerning the content 108, the author 104 may finalize the content submission process, and the contribution module 212 may then transmit the submitted content 108 to the content module 220 for storage, indexing, or publication in accordance with chosen submission option and the publication settings.

When the content 108 is submitted to be published, the content module 220 may assign each content 108 a unique identification (ID) number (e.g., WFID 5555.3 for versioned content or WFID 444444 for draft content). This unique ID may be updated in versioned content 108 by increasing the decimal positions (e.g., WFID 5555.3 updates to WFID 5555.4). Authors 104 or users 106 may search for and find public draft and public versioned content (i.e., Published works) via internet search engines.

All of the content 108 submitted by the author 104 may be accessible by the author 104 through dashboard module 210, which the author 104 may access through the notebook space. For example, the dashboard module 210, once accessed by the author 104, may retrieve the content 108 information from the content module 220 and generate a dashboard space that may include a list of all of the content 108 previously saved or published to the content module 220 by the author 104. The content module 220 may list the content 108 along with some or all of its respective details. For example, the content 108 may be listed with its catalog number, the content unique ID, title, the status, whether the content is still in progress, or if it has been published. The list may also indicate the publication format of the content 108, such as whether the content is stored as a Private Draft, Private Versioned, Public Draft, or Public Versioned. The dashboard space may also keep track of the number times the content 108 has been viewed.

The content 108 may also be searchable via a search module 208. The search module 208 may be accessible by authors 104 and users 106 by using various provided search functions provided by the search module 208 (e.g., global search, local search, advanced search). Search results may display a list of content 108 within the search criteria provided by the searcher.

When a particular content 108 is accessed, either via the search module 208 or the dashboard space, the content module 220 may generate a content space specific to that particular content 108. The content space may display all information that the author 104 provided for that content. For example, the content space may display the name of the content (e.g., sodium phosphate buffer), the content's unique ID, the date of the publication of the content if it was published, the content's format (e.g., public draft), the author's name, the content's tags and relevant category, introduction, materials (by catalog number, material name, company name, etc.), the content's description (e.g., protocol description), any attachments uploaded by the author 104, and any references and links.

The content module 220 may include a linking module 222. The linking module 222 may provide a mechanism for linking various items or products (e.g., materials, supplies, equipment, etc.) described in the content space to an associated company product web page. For example, linking module 222 may imbed a link in an entry associated with the item (e.g., the catalog number), or the link can be presented as an icon or other text in an area associated with the item listing. When selecting (e.g., clicking) on the link-embedded item entry, the author 104 or user 106 may be directed to the product page provided by the company to view more information or obtain that item.

Additionally, similar products may be listed next to the item entry (e.g., material) listed in the content space. Hypertext links to these “similar” products may be provided free or as fee for service. The linking module 222 may implement a similarity algorithm to match the listed item with a similar product as close as possible such that the authors and users will have a value-added experience when they view similar products. A list of similar products may be populated with product listings by third parties via a backdoor module 224.

For example, a company that wishes to have its products listed next to the item entry in the content space may upload a digital catalog with hyperlinks to its products via the backdoor module 224. The backdoor module 224 may extract all of the relevant information from the digital catalog, and store, sort, and/or index the information in a product database 226. The linking module 222 may then access the product database, and execute the similarity algorithm to parse the database and designate any similarity between the products listed in the database and the items listed in the content space. The linking module 222 may then utilize the determined similarity to align any of the similar products (e.g., a company's materials) with the items listed in the content space (e.g., materials listed by the author 104), and list any of the similar products acquired in this manner in a space next to the item entry in the content space. Each of the listed similar products may be identified by their name or catalog number, for example, and embedded with a hyperlink that may link out to a third party webpage associated with the similar product. By listing similar products next to items or products in the content space, the authors and users may engage in comparative shopping while viewing the content space.

The notebook module 202 may also include an auto-fill module 228, which may auto-populate a text field based on a partial entry and a search of the materials database 230. For example, when an author 104 begins to type in a material name or catalog number in a text field, the auto-fill module 228 may auto-populate the text field via an auto-fill mechanism if that material already exists in the materials database 230.

According to some aspects of the invention, the notebook module 202 may also include a profile module 234 that may receive and display profile information for the author 104 in the dashboard space or the content space. The author 104 may at any time edit the profile via the profile module 234.

According to aspects of the present invention, the notebook module 202 may include a rating module 236 that may measure an author's contribution to the portal 102. The rating module 236 may function in tandem with the content module 220 to implement a point system based on a feedback and rating mechanism applicable to authors 104, the author's content 108, as well as the individual entries within the content space (e.g., listed materials).

For example, the rating module 236 may allow all users 106 to score each published content (e.g., protocols) as well as write reviews via threaded message boards. The rating module 236 may allocate points to the author 104 based on the score. For example, the points may be allocated based on: anonymous or non-anonymous scoring of content 108 and entries within the content (e.g., materials) with either a numerical score or 5-star rating system (average, median, etc. can be applied), citations from peer-reviewed (old style) journals (e.g., Science, Nature, PLOS, data from ISI, international science index, etc.); amount of content 108 submitted and published (public versus private have different points); number of views of the author's content 108; duration of views; unique views; corporate sponsor awards to authors 104; and open access citations. Points may also be provided for the number of author registrations based on invitations from the author 104, the amount of content these invitees have provided, and the rating the invitees' content received.

The rating module 236 may provide “all-time” or “total” scores (e.g., average rating per month) or it may have scores that reflect trending for greater time-resolution on score.

Because the value of the system 200 is related to the authors 104 and the content 108 they provide, the system 200 may use the point system to redistribute to the authors 104 a fraction of revenues acquired by the system 200 via banner ads, comparative shopping links, and other revenue generating sources. Such redistribution of revenue may be controlled by a redistribution module 232, which may redistribute revenue based on the points accumulated by each author 104.

According to some aspects of the present invention, the system may allow authors 104 to request for one or more of their content 108 to be reviewed by one or more other authors 104. The review may be posted in a threaded message or similar method of communication and the contribution can be scored with a numerical rating. The score may be weighted (e.g., multiplied) by an impact factor of the reviewing author to achieve a final or composite score, which may then be converted to points by the point system and allocated to the author 104.

According to some aspects of the present invention, the notebook module 202 may include a research track, provide for addition of chemical sketches for experiments and protocols, chemical reactions, SMILES interpretation (e.g., inside a “chem box”), generation of symbols, integration of spreadsheets, tables, images, PDF, text fields. The notebook module 202 may also allow a user to add fields, attachments, dates, user defined references (e.g., links), errata section, a biological sequences area, raw data area, projects, related experiments, and other information.

According to some aspects of the present invention, the notebook module 202 may include a project management system including a Gantt chart integrated with an electronic calendar. The Gantt chart may be integrated with 3rd party calendars, such as Google Calendar. The project management system may be used by authors 104 to organize the authors' respective research projects including research tracks, experiments, protocols, materials and other related information.

According to some aspects of the present invention, the notebook module 202 may include human resources management (HRM) system for scientists to manage the human resources that are required to execute their work.

According to some aspects, the notebook module 202 may include customer resource management (CRM) system integration where required for accounts with clients (e.g., advertisers).

According to some aspects of the present invention, the notebook module 202 may include an advertisement dashboard that allows clients to electively advertise to target audiences that use the services associated with the portal 102.

The convergence of scientific content 108 and shared user experiences via the portal 102 may serve to expedite the scientific process.

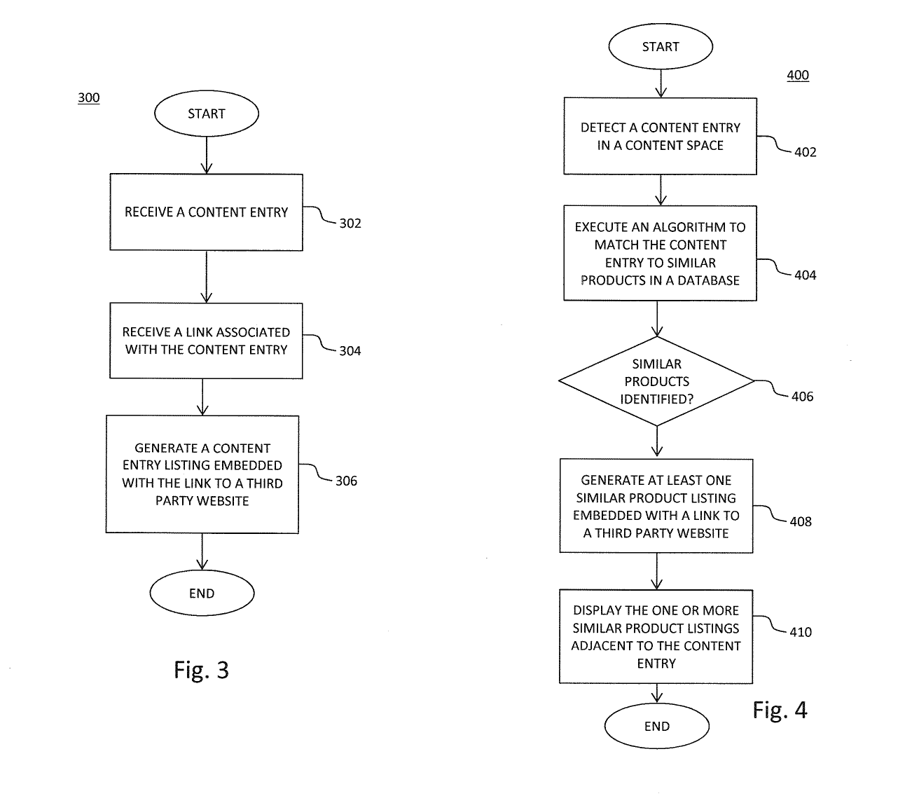

FIG. 3 illustrates an example flow diagram of a method 300 for embedding hyperlinks in a content space. As shown in FIG. 3, in block 302, a content entry may be received. For example, when entering information related to a material, the author 104 may enter in the contribution space various information identifying the material, such as a catalog number, material name, and company name.

In block 304, a link associated with the content entry may be received. For example, when entering information related to a material, the author 104 may enter in the contribution space hyperlink to the material on a website of a company that manufactures and/or sells the material.

In block 306, a content entry listing embedded with the link to a third party website may be generated, and the process may end. For example, when the author 104 submits the content with the content entry, the content module 220 may generate a content space that includes a listing of the content entry embedded with the hyperlink to the website of the company that manufactures and/or cells the material.

FIG. 4 illustrates an example flow diagram of a method 400 for generating similar product listings in a content space. As shown in FIG. 4, in block 402, a content entry may be detected in a content space. For example, the linking module 222 may detect an entry for a particular material in a content space, such as the material's catalog number, its name, and company name manufacturing and/or selling the material.

In block 404, an algorithm may be executed to match the content entry to similar products in a database. For example, linking module 222 may access a product database 226 (including information from digital catalogs provided by third parties) and execute a similarity algorithm to locate any products listed in the product database 226 that are similar to the material listed in the content space.

In block 406, a determination may be made as to whether a similar product has been identified in the database. If so, the process may proceed to block 408, if not, the process may end. For example, the linking module 222 may identify in the product database 226 via the similarity algorithm a product similar to the material listed in the content space.

In block 408, at least one similar product listing embedded with a hyperlink to a third party website may be generated. For example, the linking module 222 may generate one or more listings of similar products identified in the product database 226, where the generated listings are embedded with hyperlinks to respective company websites that manufacture and/or sell the similar products.

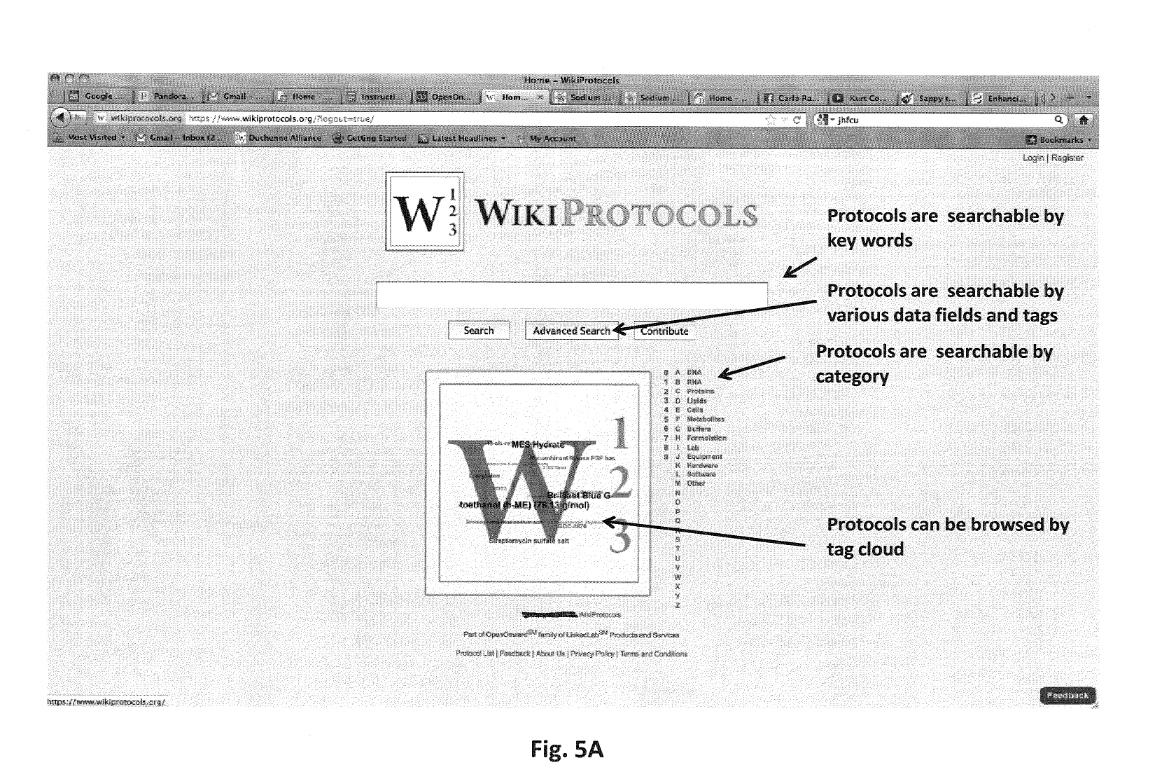

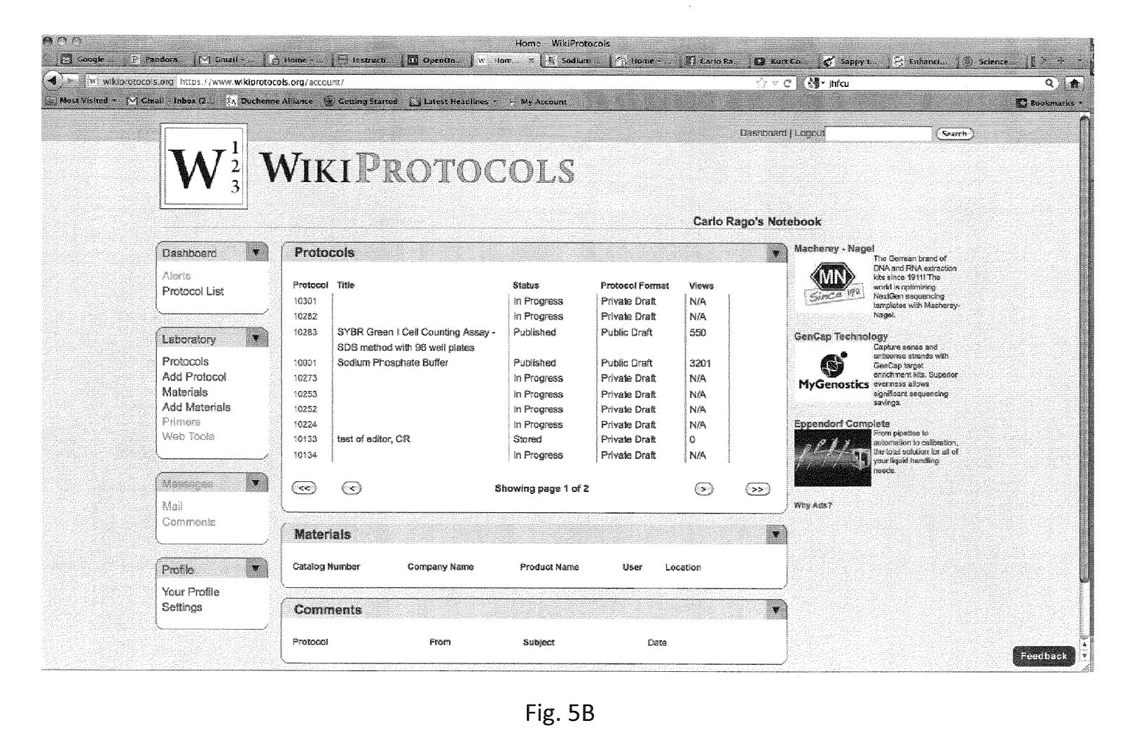

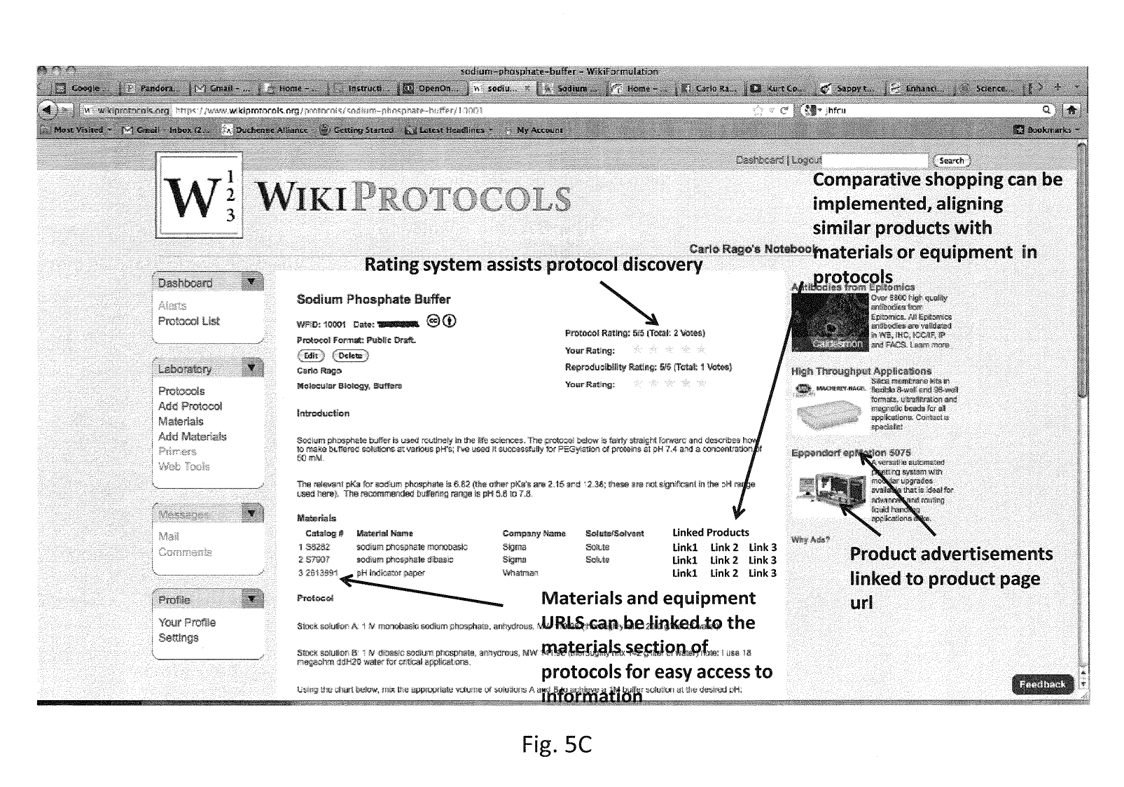

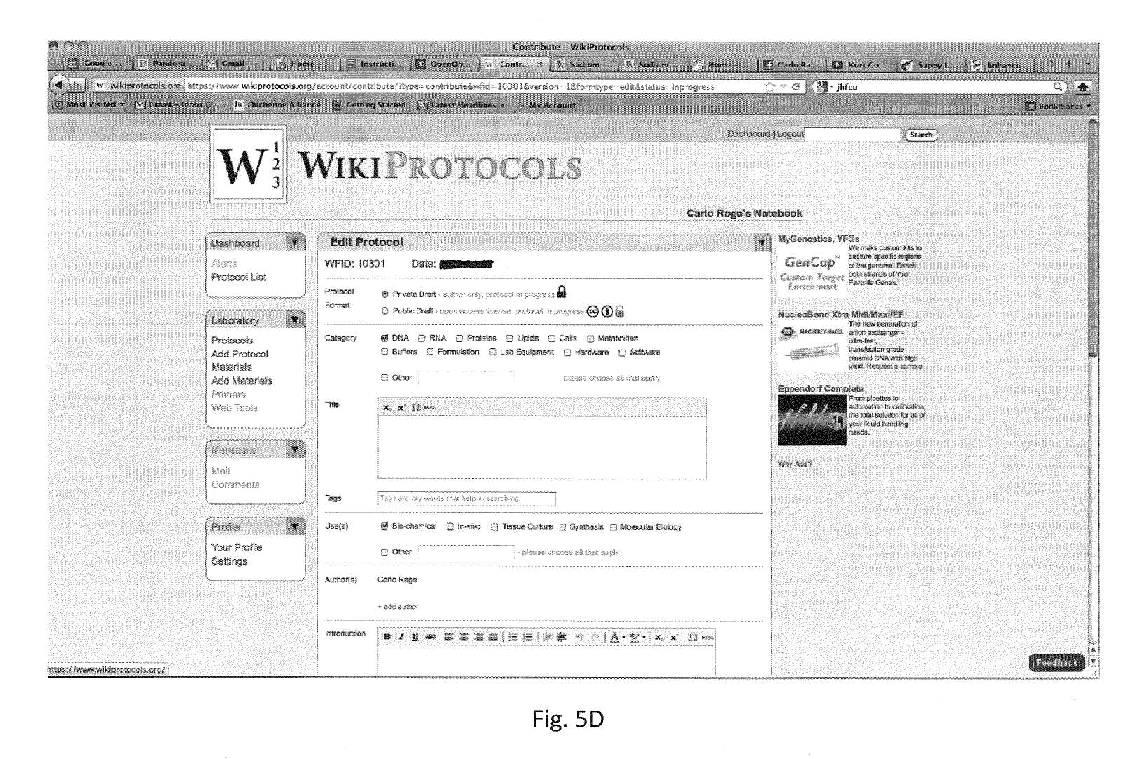

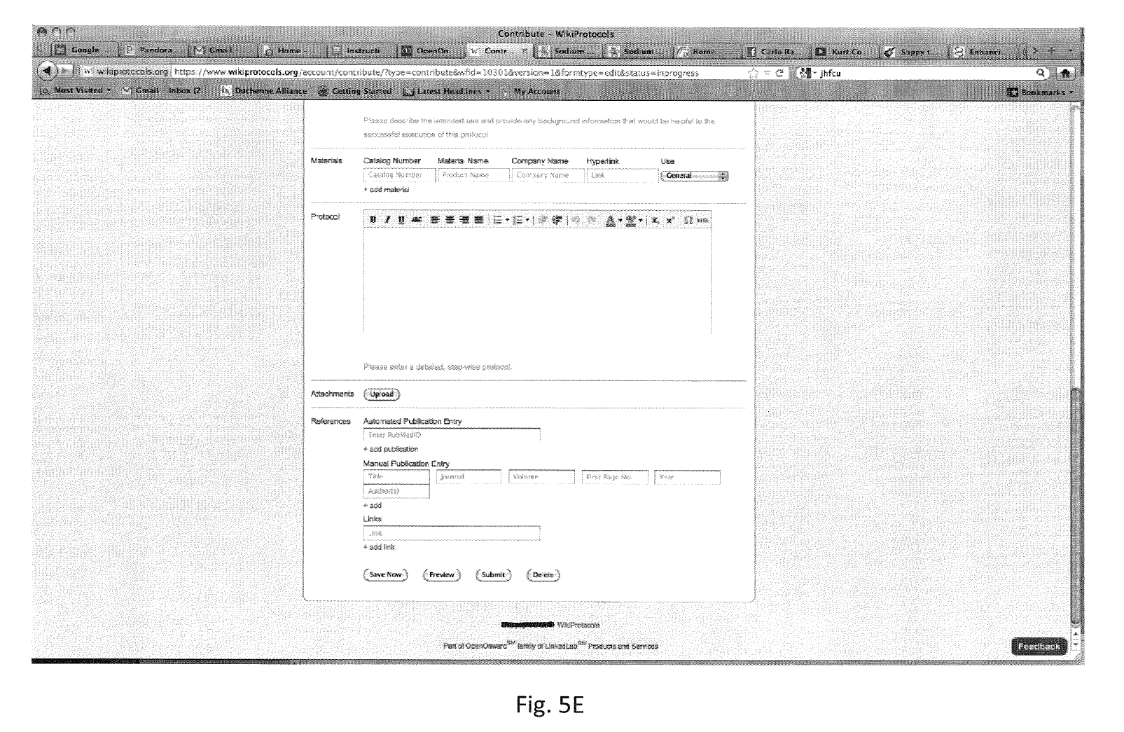

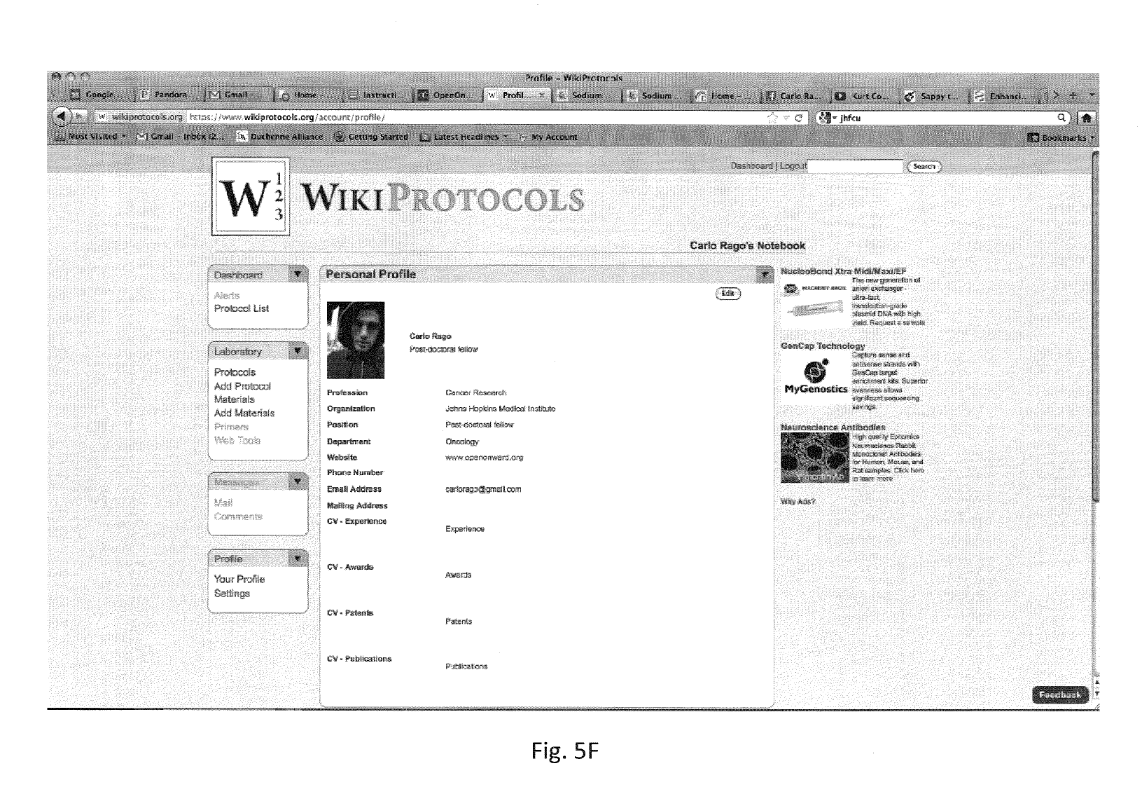

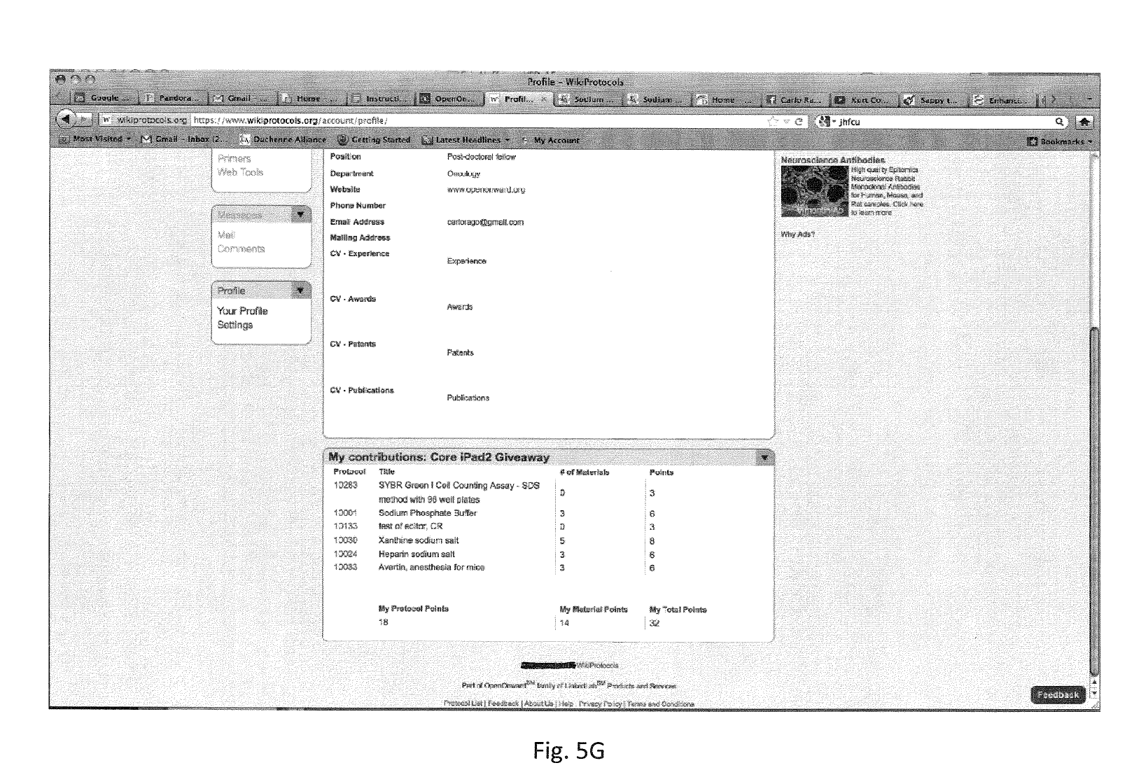

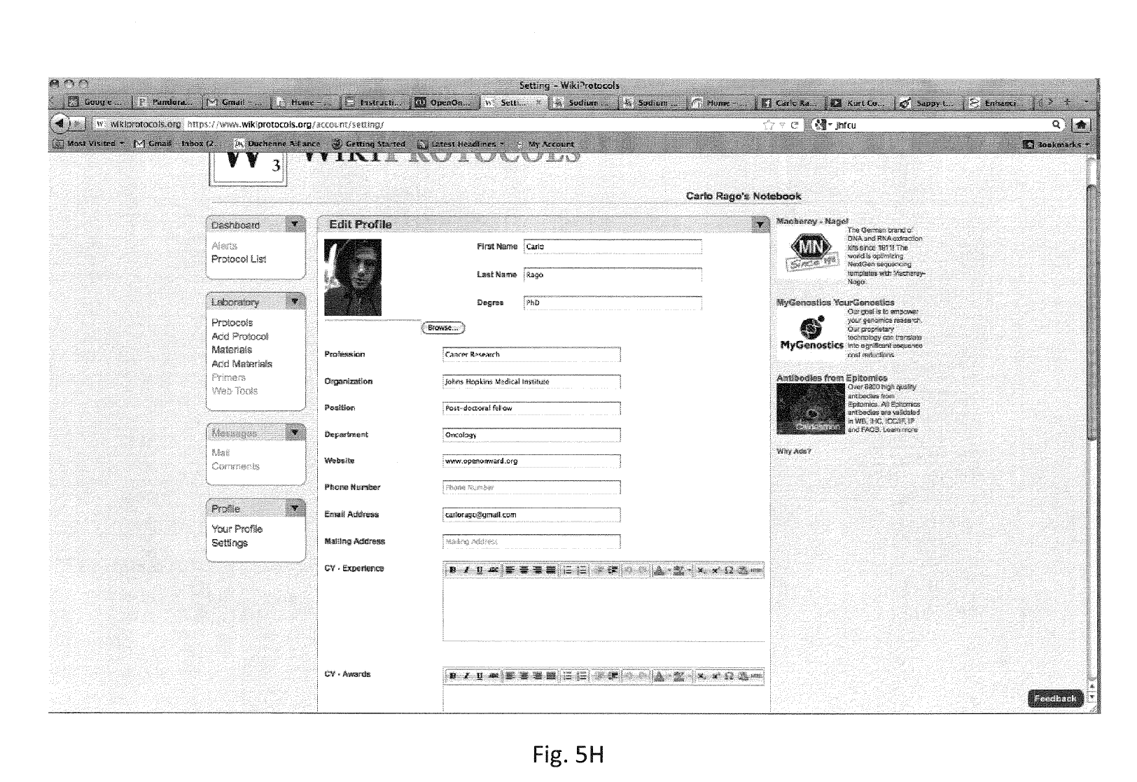

In block 410, the at least one similar product listing embedded with the hyperlink may be displayed adjacent to the content entry. For example, the linking module 222 may display the one or more generated product listings adjacent to the material listing in the content space, as exemplified in FIG. 5C.

FIGS. 5A-5H illustrate example screen shots of various aspects of the present invention.

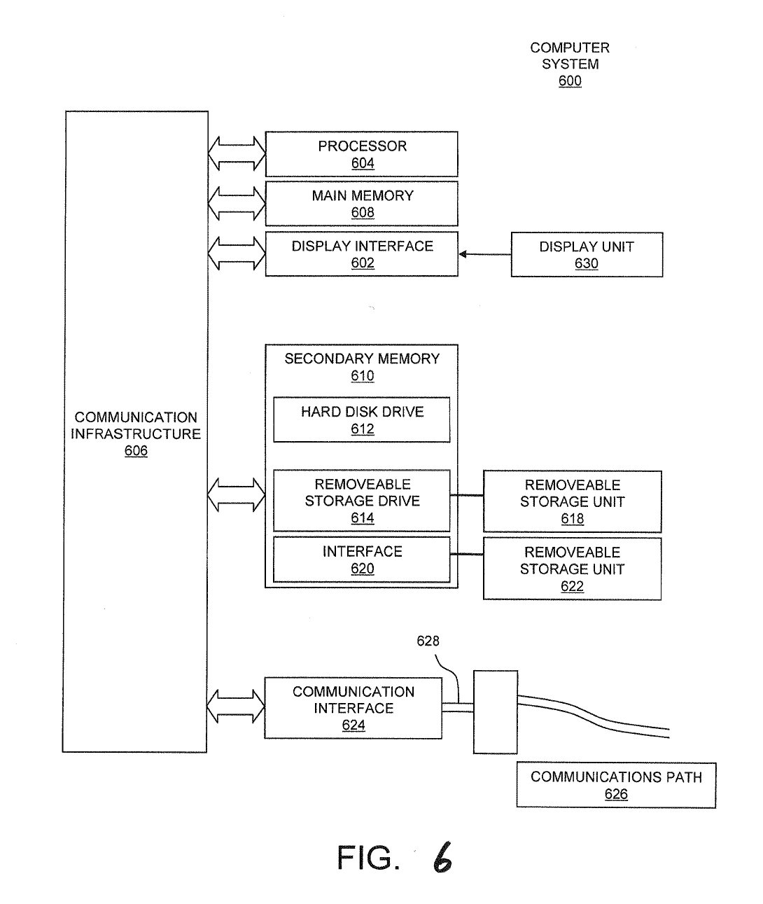

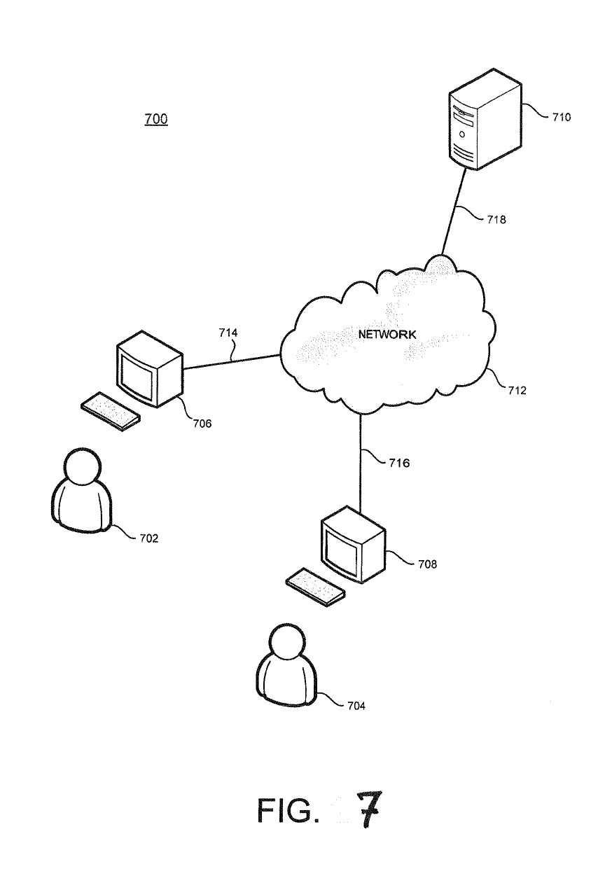

Aspects of the present invention, as well as programming functions performed via a separate terminal, may be implemented using a combination of hardware, software and firmware in a computer system. In an aspect of the present invention, the invention is directed toward one or more computer systems capable of carrying out the functionality described herein. An example of such a computer system 600 is shown in FIG. 6.

Computer system 600 includes one or more processors, such as processor 604. The processor 604 is connected to a communication infrastructure 606 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc., which is read by and written to removable storage drive 614. As will be appreciated, the removable storage unit 618 includes a computer usable storage medium having stored therein computer software and/or data.

Alternative aspects of the present invention may include a secondary memory 610 and may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 614, a hard disk installed in hard disk drive 612, main memory 608, secondary memory 610, and signals 628. These computer program products provide software to the computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 610 to perform the features of the present invention. Accordingly, such computer programs represent controllers of the computer system 600.

In an aspect of the present invention where the invention is implemented using software, the software may be stored in a computer program product and loaded into computer system 600 using removable storage drive 614, hard drive 612, or communications interface 624. The control logic (software), when executed by the processor 604, causes the processor 604 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

FIG. 7 shows a communication system 700 usable in accordance with aspects of the present invention. The communication system 700 includes one or more accessors 702, 704 (also referred to interchangeably herein as one or more “users” or “members”) and one or more terminals 706, 708. According to one aspect, data for use in accordance with the present invention is, for example, input and/or accessed by accessors 702, 704 via terminals 706, 708, such as personal computers (PCs), minicomputers, mainframe computers, microcomputers, telephonic devices, or wireless devices, such as personal digital assistants (“PDAs”) or a hand-held wireless devices coupled to a server 710, such as a PC, minicomputer, mainframe computer, microcomputer, or other device having a processor and a repository for data and/or connection to a repository for data, via, for example, a network 712, such as the Internet or an intranet, and couplings 714, 716, 718. The couplings 714, 716, 718 include, for example, wired, wireless, or fiberoptic links. According to another aspect, the method and system of the present invention may operate in a stand-alone environment, such as on a single terminal.

While the foregoing disclosure discusses illustrative aspects and/or embodiments, it should be noted that various changes and modifications could be made herein without departing from the scope of the described aspects and/or embodiments. Other aspects will be apparent to those skilled in the art from a consideration of the specification or from a practice of the invention disclosed herein. Furthermore, although elements of the described aspects and/or embodiments may be described in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for linking out to product websites in an electronic laboratory journal environment, comprising:
receiving a content entry in a content space;
receiving a hyperlink associated with the content entry in the content space, the hyperlink configured to link out to a third party website with affiliation to the content entry; and
generating in the content space a content entry listing having embedded therein the hyperlink that is configured to link out to the third party website.

2. An apparatus, comprising:
a contribution module configured to:
receive a content entry in a content space;
receive a hyperlink associated with the content entry in the content space, the hyperlink configured to link out to a third party website with affiliation to the content entry; and
a linking module configured to generate in the content space a content entry listing having embedded therein the hyperlink that is configured to link out to the third party website.

3. A system, comprising:
means for receiving a content entry in a content space;
means for receiving a hyperlink associated with the content entry in the content space, the hyperlink configured to link out to a third party website with affiliation to the content entry; and
means for generating in the content space a content entry listing having embedded therein the hyperlink that is configured to link out to the third party website.

4. A computer program product comprising a non-transitory computer-readable medium having control logic stored therein for causing a computer to perform linking, the control logic comprising:
code for receiving a content entry in a content space;
code for for receiving a hyperlink associated with the content entry in the content space, the hyperlink configured to link out to a third party website with affiliation to the content entry; and
code for for generating in the content space a content entry listing having embedded therein the hyperlink that is configured to link out to the third party website.

5. A method for linking out to product websites in an electronic laboratory journal environment, comprising:
detecting a content entry in a content space;
searching a database using an algorithm that is configured to identify product listings within the database that are similar to the content entry;
determining whether similar product listings have been identified;
generating at least one similar product listing embedded with a hyperlink to a third party website with affiliation to the at least one similar product listing; and
displaying within the content space the at least one product listing adjacent to the content entry.

6. A method for measuring contribution by authors and redistribution of revenue to authors, comprising:
quantifying contribution by authors based on parameters attributed to each of the authors and content submissions of each of the authors, the parameters including a number of the content submissions by each of the authors, a rating of the content submission, a total number of views of the content submissions, a number of unique views of the content submissions, and an average viewing time of the content submissions; and
distributing awards to each of the authors based on the respective quantified contribution of each of the authors.
